(19) United States
(12) Patent Application Publication
(10) Pub. No.: US 2011/0119293 A1
(43) Pub. Date: May 19, 2011

(54) Method And System For Reverse Pattern Recognition Matching

(76) Inventors: Randy Gilbert Taylor, Brooklyn, NY (US); Evan Frohlich, New York, NY (US)

(21) Appl. No.: 12/909,159

(22) Filed: Oct. 21, 2010

Related U.S. Application Data
(60) Provisional application No. 61/253,664, filed on Oct. 21, 2009.

(51) Int. Cl. G06F 17/30

(52) U.S. Cl. 707/769; 707/825; 707/803; 707/E17.01; 707/E17.014; 707/E17.044

(57) ABSTRACT

Systems and methods to perform reverse pattern recognition matching are provided in which identical and similar media files and related information may be identified using the media file itself as a starting point for a query of stored information. Unique identifiers may be created from an initiating media file using cryptographic and perceptual hash functions. The resulting hashes may be compared to data of other media files using hamming and other comparative methods. In an embodiment, the invention may be used to identify copyright ownership of non-attributed creative works. Searches for similar or identical media files may be performed using based on a media file, which may not be controlled by a rights holder of the media file.

### BACKGROUND OF THE INVENTION

The Copyright Act of 1976 (An Act for the general revision of the Copyright Law, title 17 of the United States Code, and for other purposes) changed copyright law in the U.S.A. by no longer requiring authors and rights holders of creative works to affix their identity on, in or adjacent to the copyrighted work. This is summarized in the catch phrase of industry trade associations: “When it's created, it's copyrighted.” Since identifying copyright authorship or ownership is no longer required to protect one's copyright, many creative works have been published without identifying or otherwise attributing the work to the creator or copyright owner.

The use of digital media and similar files, such as photographic images, on the Internet has also multiplied exponentially. This increase is due, in part, to the ease of creating images with modern digital cameras and the unencumbered ability to copy and share media files via the Internet. As with other works of authorship, media files made available via the Internet often do not provide attribution to the rights holder, because such attribution is not required to validate copyright ownership.

### BRIEF SUMMARY OF THE INVENTION

The invention provides methods and systems to perform reverse pattern recognition matching and to perform various actions based on matches, such as registering information to be associated with files that result from the matching method. As an example, the invention may allow users to find and track rights holder information for media files, and to retrieve rights information using a digital copy of a work that has no rights holder information associated with it at a particular location, in some cases by using the media file itself to initiate the process of retrieving the rights information. The embodiments of the invention may be implemented in a variety of ways.

A method according to an embodiment of the invention may include receiving an identification of a media file from a user, generating a unique identifier for the media file, searching a media file registry for the unique identifier, where the media file registry stores a plurality of records, each of which associates a previously-generated unique identifier for a media file with rights holder information for the media file, retrieving rights holder information for the media file from the registry, and presenting the rights holder information to the user. The method may further include displaying the media file to the user concurrently with the rights holder information. The rights holder information for the media file may be received from a rights holder, a third-party source such as a government-run copyright registry, or combinations thereof. The method may further include providing the user with the ability to perform a commercial action related to the identified media file, such as obtaining a license to use the media file, obtaining an authorized copy of the media file, obtaining a report describing rights holder information for the media file, or a combination thereof. The media file may not be controlled by the rights holder. The method may include identifying the rights holder of the media file from a copy of the media file that has no rights holder information provided at the location of use of the media file, providing contact information for the rights holder of the media file whether or not the contact information was known at the location of use of the media file, or both.

A method according to an embodiment of the invention may include receiving an identification of a media file from a user, generating a unique identifier for the media file, receiving rights holder information from the user and storing a record of the unique identifier and the rights holder information in a media file registry. The method also may include displaying the media file to the user concurrently with the rights holder information, displaying a list of similar media files to the user, obtaining additional rights holder information from a third-party source such as a government-run copyright registry, or any combination thereof. The method also may include generating source code for a web page that is configured to register one or more media files on the web page in the media file registry. The generated code also may limit usability of the code to a specific web domain, specific user, or combinations thereof, such as by storing data used to limit usability of the code to a browser cookie of a user. The generated code also may automatically add a unique identifier and information to the media file registry for all media files at a web page containing the code. The generated code may check for additions of new media files to the web page, and may register the new media files in a media file registry. The generated code may determine if media files on the web page containing the code have already been added to the media file registry, and may refrain from adding media files on the web page to the registry if the web page is unchanged since a previous verification. The method may further include registering the media file in a government-run registry, and such registration may be performed automatically based on saved preferences of the user. Registering the media file may include assembling necessary registration information from the media file registry. The method may include receiving a second unique identifier and information for the media file, where the media file is created in and transmitted from a mobile phone, a digital camera, a computer software product, or other device or component, and storing the second unique identifier and the received information in the media file registry.

Embodiments of the invention may include identifying a second media file similar to the media file identified by the user by comparing one or more unique identifiers associated with the identified media file and the second media file, where the unique identifiers may be perceptual hashes, which may be compared by calculating a hamming distance between the identifiers. Embodiments also may include identifying a plurality of other media files from a first media file and storing a unique identifier for each of the plurality of other media files in the media file registry. Embodiments also may not store a copy of a media file identified by the user and/or registered or processed by a media file registry.

Embodiments of the invention may include systems, devices, and computer program products corresponding to or usable with these methods.

Additional features, advantages, and embodiments of the invention may be set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification; illustrate embodiments of the invention and together with the detailed description serve to explain the principles of the invention. No attempt is made to show structural details of the invention in more detail than may be necessary for a fundamental understanding of the invention and various ways in which it may be practiced.

FIG. 1 shows an example of a system suitable for use with embodiments of the invention.

FIG. 2 shows an example process according to an embodiment of the invention.

FIG. 3 shows an example of embodiments in which a rights holder may register media files with a registry, and in which the registry may be used to identify ownership and other rights holder information for a media file which may include a non-attributed work.

FIG. 4 shows an example process for performing data ingestion and analysis according to an embodiment of the invention.

FIG. 5 shows an example of a user interface for displaying the media files identified at a particular URL according to an embodiment of the invention.

FIG. 6 shows an example of a user interface displaying detailed information for a single media file according to an embodiment of the invention.

FIG. 7 shows an example report for a single media file according to an embodiment of the invention.

FIG. 8 shows an example user interface displaying the media files at a particular URL that includes media files both registered and not registered in the associated registry according to an embodiment of the invention.

FIG. 9 shows a computer suitable for use with embodiments of the present invention.

FIG. 10 shows a schematic diagram of a processing unit suitable for use with embodiments of the present invention.

FIG. 11 shows an example of a computer network suitable for use with the present invention.

### DETAILED DESCRIPTION OF THE INVENTION

It is understood that the invention is not limited to the particular methodology, protocols, topologies, etc., as described herein, as these may vary as the skilled artisan will recognize. It is also to be understood that the terminology used herein is used for the purpose of describing particular embodiments only, and is not intended to limit the scope of the invention. It also is to be noted that as used herein and in the appended claims, the singular forms “a,” “an,” and “the” include the plural reference unless the context clearly dictates otherwise.

Unless defined otherwise, all technical and scientific terms used herein have the same meanings as commonly understood by one of ordinary skill in the art to which the invention pertains. The embodiments of the invention and the various features and advantageous details thereof are explained more fully with reference to the non-limiting embodiments and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein.

Any numerical values recited herein include all values from the lower value to the upper value in increments of one unit provided that there is a separation of at least two units between any lower value and any higher value. As an example, if it is stated that the concentration of a component or value of a process variable such as, for example, size, angle size, pressure, time and the like, is, for example, from 1 to 90, specifically from 20 to 80, more specifically from 30 to 70, it is intended that values such as 15 to 85, 22 to 68, 43 to 51, 30 to 32 etc., are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Particular methods, devices, and materials are described, although any methods and materials similar or equivalent to those described herein can be used in the practice or testing of the invention. All references referred to herein are incorporated by reference herein in their entirety.

As used herein, a “media file” refers to a computer- or processor-readable file that embodies one or more creative works of authorship. Computer- or processor-readable files may be read, manipulated, or otherwise used by any suitable computing or processing device, including, e.g., desktop computers, laptop, netbook, and other portable general-purpose computers, mobile phones, personal digital assistants (“PDAs”) and other mobile computing devices, special-purpose computing devices, and other similar devices (herein referred to as a “device” or “devices”). A “media file” may take various forms including, but not limited to, video, images, illustrations, movies, animation, audio, textual content, mashups or other combinations of multiple content sources or types, and other creative works. A media file may include text, such as where an image includes one or more characters, words, or other text. And, media files may include or have associated with them various data stored in the file as text or metadata, such as Adobe File Info metadata, Information Interchange Model (IIM) metadata, one or more Extensible Markup Language (XML) files associated with the media file, Extensible Metadata Platform (XMP) metadata, Exchangeable Image File Format (EXIF) metadata, Picture Licensing Universal System (PLUS) data and/or other data that is accessible to users of the media file (herein referred to as a “embedded metadata”). A single media file may contain one or more works of authorship protected by copyright or not protected by copyright, and a single work of authorship may be embodied in multiple media files. A media file may include a digital or digitized version of an original non-digital work.

As used herein, a “rights holder” refers to an entity that owns or controls a legal right associated with a media file or who claims to own or control such legal rights. Typically, the primary rights holder will be the copyright owner of the media file, though this is not necessary. A rights holder may hold one or more of the rights afforded by copyright law, and multiple rights holders may hold rights to a single work.

As used herein, a “non-attributed work” refers to a media file for which creator, owner, or other rights holder information is not readily available or for which no contact information for such creator, owner or other rights holder is readily available. Thus, if a media file does not have rights holder attribution concurrently displayed with or otherwise readily available with the media file, it is classified as a “non-attributed work.” Further, a media file that provides rights holder attribution, but for which there is no apparent reasonable means to contact the rights holder, is also classified as a “non-attributed work.” Some persons skilled in the art may refer to a “non-attributed work” as used herein as an “orphan work” or an “orphaned work.”

Initially, some visual content used on the Internet (such as images and video) was provided as a low-resolution copy or lower-quality derivative of the original content. For example, low-resolution images may be provided as a “preview” or demonstration of a higher-quality work offered for sale or license by the rights holder. Such low-resolution content often has been available from the rights holder to encourage sale of high-resolution content. Over time, this low-resolution content, including visual content, has become a primary reason for people to use the Internet. In many cases, these low-resolution uses of media files occur without any compensation to the content rights holder. This may occur, in part, as a result of the difficulty of identifying owners of unattributed creative works.

As the Internet and relatively high-bandwidth connections to the Internet have grown in popularity and availability, there has been rampant copying of media files, particularly on the World Wide Web. This widespread copying further multiplies the number of unidentified media files subject to unauthorized duplication.

Thus, not only have up to billions of copyrighted works become accessible online without proper attribution, many times more have been replicated without authorization for use, also without author attribution. As a result, up to trillions of images are accessible via the Internet with no authorship or ownership information.

The U.S. Copyright Office provides various mechanisms for authors and rights holders to register created works, thus establishing a date of first publication, ownership, and various other information. However, the Copyright Office does not provide a means to execute a “reverse” search of registered works, i.e., a way to search by electronic means starting from a media file or other work itself. The Copyright Office also does not provide an electronic interface that shows the work itself concurrently with the registration information maintained by the Copyright Office.

For these and other reasons, it can be quite difficult, if not impossible, to identify the proper owner or other rights holder of a media file or underlying work in an efficient manner when it is a non-attributed work. In many cases, doing so may be difficult or impossible at all. The same problems occur when identifying infringers or potential infringers of copyrighted works.

The shift to content as the end item to consume, the increase in unauthorized copying, and the general lack of rights holder information associated with that content suggest the need for a system and method capable of identifying rightful ownership for creative works contained in media files that have no authorship or ownership information readily available as part of that file or displayed concurrently with the file. Similarly, they suggest a need in the art for a system and method capable of automatic or semi-automatic retrieval of rights holder information based on unattributed copies of media files.

Embodiments of the systems and methods described herein may address these and other problems by allowing all copies of creative works in digital form to link back to rights holder information that may be centralized in a registry, including a copyright registry. The rights holder information may be obtained from multiple sources and stored, maintained, and provided to users in a uniform format. In general, inventive systems and methods described herein allow for the identification of owners or other rights holders of creative works contained in media files and, more particularly, to methods and systems for storing copyright ownership and/or authorship information for creative works in a centralized registry and retrieving that information for copies of those works in digital form that have no rights holder information associated with them at their location of use.

In some embodiments, the starting point to identify a rights holder of a media file is a copy of the media file itself, which may have no ownership or other rights holder information associated with it at the location at which the media file is initially identified.

In some embodiments, rights holder information may be identified without requiring each media file to be tagged with a copyright identifier or other similar identifier prior to the media file being registered with a registry, and the registered media files need not be stored in a database or other permanent or long-term storage mechanism attached to or in the registry. In some embodiments, a watermark, identification, or other tag may be used.

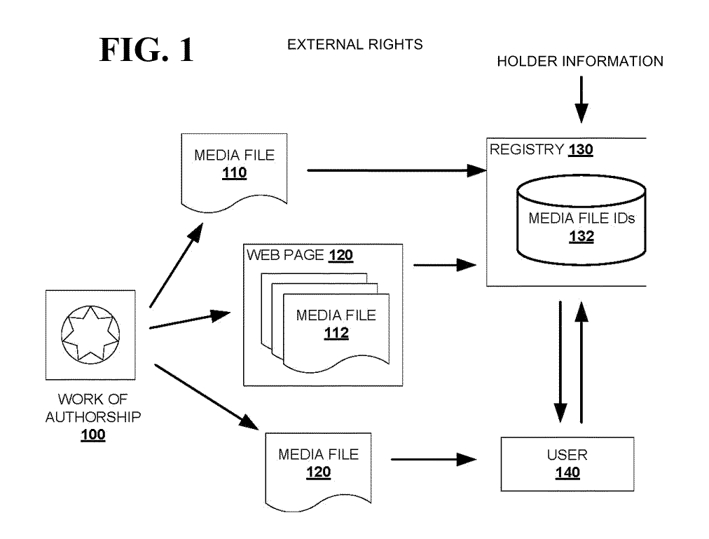

FIG. 1 shows an example of a system suitable for use with the invention. A work of authorship 100 may be embodied in one or more media files 110, 112, 120. The media files may be referenced by or contained in various locations, such as web pages 120. Generally, each media file may be accessed by a location address, such as a URL. As described in further detail below, a first URL may identify the location of the media file itself, and one or more other URLs may identify the location of a resource, such as a web page, that incorporates, links to, or references the media file. Each media file 110, 112, 120 may include rights holder information, such as by embedded tags or other text, from which initial copyright and other ownership information may be obtained. This information may be retrieved and stored by the registry system 130. Other external rights holder information for the creative works in the media file may be obtained from sources other than the media file. For example, the registry may access or be provided information from one or more third-party media files for which ownership information is being sought or being provided, which may be received from the rights holder or from third-party repositories of information. The process of obtaining such information is described in further detail below.

The registry 130 may store information and data relating to the media files. The registry also may generate and store identifiers 132 for each media file that the system identifies or that is identified to the system by a rights holder or other user. Rights holder, ownership, and other relevant data relating to the media files may be stored by the system in one or more databases, and may be linked to the generated or received identifiers. The identifiers may be unique for each media file, and one or more media files may be associated with a work of authorship.

According to embodiments of the invention, some media files 110, 112 may be identified by the system, while others may not initially be identified, such as media file 120. The unidentified media file 120 may be referred to as a non-attributed work until such time as the media file 120 is associated with rights holder information by the registry 130.

In some embodiments, a user 140 may identify a media file 120 to the registry 130. The media file may be, for example, a non-attributed work, or it may be a media file for which the user wishes to provide rights holder information to the registry, such as where the user 140 is a rights holder for the media file 120 or a credible source of information about the media file. In some embodiments, the media file 140 may be a non-attributed work for which copyright and/or other ownership information is desired by the user 140. By submitting the location of the media file 120 to the registry 130, the user 140 may initiate a copyright owner identification process, as described in further detail below.

When a rights holder is identified for a media file, such as a media file 120 provided by a user, supplemental information and data related to the media file may be accessed to obtain relevant copyright information and related data for creative content contained in the media files, including, for example, from the U.S. Copyright Office or other repository of relevant information or data. Such information may be obtained from external sources as previously described.

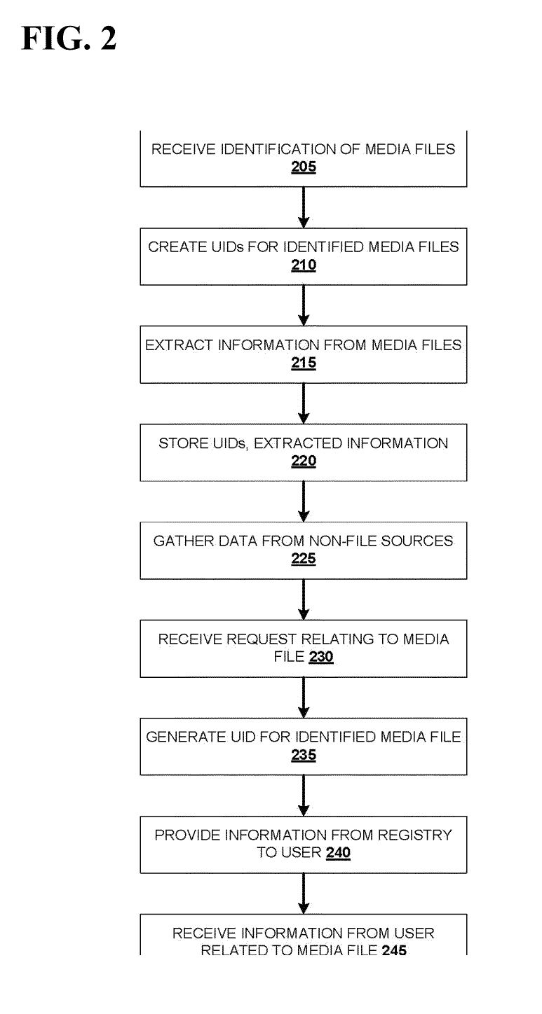

FIG. 2 shows an example process according to an embodiment of the invention. At 205, one or more media files is identified to a registry, such as the registry 130 described with respect to FIG. 1. The media file may be identified by a rights holder or other user to register the media file with the registry, or by another user who wishes to obtain rights holder information for the media file, or by an automated process that requires such information. At 210, the system may create unique identifiers for each media file and, at 215, may extract relevant ownership information and other rights holder information from the media file itself, if any is present. This information may be added to a database maintained by the registry and associated with the media file identifier at 220. At 225, the system may gather data, such as rights holder information from other sources, relating to media files listed in the registry, and store this data in the database. At 230, the registry may receive a request relating to a media file from a user. The request may identify a media file for which the user wishes to obtain rights holder information, a media file for which the user wishes to provide rights holder information, or a combination thereof. After receiving identification of the media file, at 235 the system may generate an identifier for the media file. If the user wishes to obtain information related to the media file, at 240 the system may provide any such information stored in the registry's database and associated with the identifier generated for the identified media file. The system also may provide information from other databases and sources, such as, for example, the U.S. Copyright Office or other third-party repositories of relevant information. If the user wishes to provide information related to the media file, at 245 the registry may receive information from the user and associated it with an identifier generated for the media file. If the identifier is already present in the registry, the user may provide information that is then associated with a previously-stored identifier. For example, the user may identify himself as a rights holder for the media file.

The media file may have various identifiers associated with it. For example, the identifier may be derived from the media file itself, such as a hash or perceptual hash as described herein. Other identifiers that may be associated with a media file include registration numbers and other identifiers from the U.S. Copyright Office or other government-run copyright registry, unique identifiers generated by the registry system, and third-party identifiers from other sources.

It will be understood that the specific steps described with respect to FIG. 2 may be performed in various other orders than the example specifically described, and that other combinations of steps may be performed. For example, a registry may provide information about a media file to a user who wishes to provide information about the media file before, after, or while the registry receives information about the media file from the user.

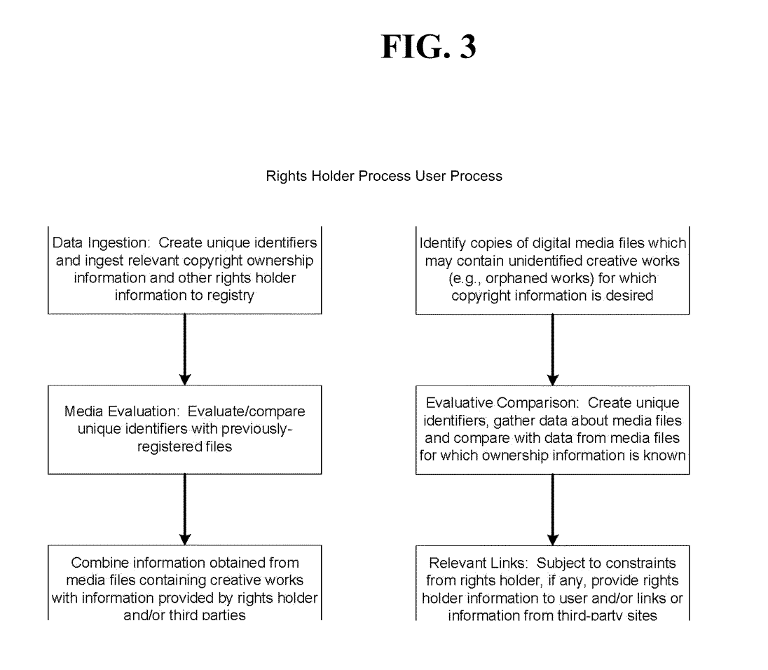

FIG. 3 shows a specific example of embodiments in which a rights holder may register media files with a registry, and in which the registry may be used to identify ownership and other rights holder information for a media file which may include a non-attributed work. Processes associated with the rights holder and with a user who is not a rights holder of the relevant media file are shown.

The general process of generating identifiers and adding previously un-identified media files and/or information associated with a media file to the registry may be referred to herein as a “data ingestion” process for the registry. Data ingestion processes according to embodiments of the invention may include examining a database to determine whether a media file is already listed in the database, presenting and receiving information associated with the media file, such as rights holder information, updating information stored in the database and associated with a unique identifier generated for a media file, or any combination thereof.

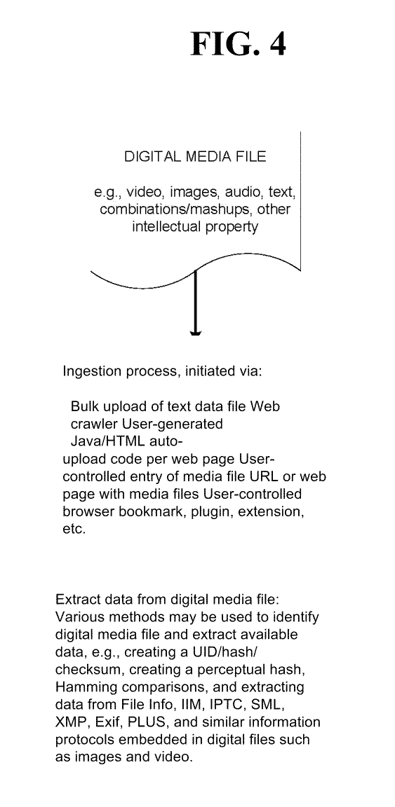

FIG. 4 shows an example process for performing data ingestion and analysis according to an embodiment of the invention. As shown in FIG. 4, different methods and techniques may be used to initiate the storage or lookup of a media file in the registry, and to add or obtain information about a media file, such as creator and ownership information, to or from the registry.

In general, a media file may be registered with the registry system by providing the media file or a location at which the media file is available to the registry, and providing rights holder information for the file. The media file may be provided through any suitable technique, including, e.g., sending over a network such as the Internet, and using any suitable device including, e.g., a desktop computer, mobile computer, mobile phone, PDA, or other portable computing or processing device. Once a media file is registered, it may be used to provide rights holder information to a subsequent user that requests information for the provided media file or a related media file as described herein.

In an embodiment a “bulk upload” may be provided. For example, a rights holder may provide a list that describes multiple media files, such as a tab-delimited text data file that contains a list of media files and a URL of each media file, ownership information, URL(s) of the web page(s) at which the media files are located, e-commerce link(s) to one or more URLs designated by the registered rights holder, the creator's name, the copyright owner's name, the registration number for this creative work if registered with the U.S. Copyright Office, the title of the work, or any other information about each media file. As another example, a user may provide a list of URLs of media files for which information is desired. Users may be human, automated or mechanical in nature, or a combination thereof.

In an embodiment, a web crawler (also known as a web spider, web robot, automatic indexer, or search engine crawler) or other known device or process may navigate autonomously or as directed to specified or random URLs to identify media files and/or gather data and information about media files at that location. Each media file may be added to the registry, such as by means of a unique identifier as previously described, and the information obtained by the crawler stored and associated with the media file. In another example, each media file identified by the crawler may be compared to media files listed in the registry to determine if information is available for the identified media files. As another example, a web crawler may automatically query other databases to obtain information about media files, such as by accessing the U.S. Copyright Office or other databases via a provided API or other means.

In an embodiment, HTML, Java, or other code may be placed on a web page or device to provide ingestion or lookup functionality for media files contained in or referenced at the web page or device. For example, a rights holder may include code on each web page for which the rights holder wishes to claim ownership for all creative works contained in media files at that web page. When the web page is loaded by any user, a data ingestion process for media files on that page with the copyright and ownership information of the registered user who generated the code may be initiated as previously described. As another example, code may be placed on a web page or device that enables a lookup of information from a registry for media files included in the web page, and displays the information to the user, such as via a mouseover of each media file or other mechanism. As another example, code may be placed on a device that initiates a data ingestion process as described herein for media files upon creation of a media file.

In an embodiment, a user may provide a URL that refers to a single media file to the registry system to initiate a data ingestion process for the single media file or to obtain information associated with the single media file. For example, a rights holder may identify a media file to be added to the registry and provide information to be associated with the media file. As another example, a user may identify a single media file for which information is desired. Similarly, in an embodiment, a user may submit a URL to a web page that contains a multiplicity of media files to initiate a data ingestion process for the media files or obtain information, if any, associated with each of the media files.

In an embodiment, a user may use a bookmark, bookmarklet, web browser plugin, or other similar mechanism to initiate a scripted action that is stored in a, browser cookie, or code that is embedded in the mechanism or at a web site, such as a web site provided by the media file registry. The scripted action may initiate a data ingestion process for those media files listed on or included in a web page displayed in a web browser or device, or may initiate a query to obtain information for those media files on the web site or device that are registered with the registry system.

In an embodiment, a user may provide a media file directly from their computer, for example by selecting a locally-stored file to be uploaded to a registry system. A user may then provide and/or request rights holder information for the media file. A user also may register a media file with the registry, or request rights holder information for a media file registered with the registry, from any suitable computing or processing device. For example, a media file may be provided from a mobile phone, a camera, a software product, or other devices. The media file may be provided to the registry over the Internet or other network, and the provision of a media file to the registry may be initiated by human or automated action, which may be based on parameters predetermined by the system and the user. The use of such mechanisms will be readily understood by a person skilled in the art.

As previously described, information about a media file may be obtained from data integrated with or referenced directly or indirectly by the media file, such as integrated metadata, and associated with a unique identifier generated for the media file. Specific examples of information sources include those known in the art, such as Adobe File Info metadata, Information Interchange Model (IIM) metadata, one or more Extensible Markup Language (XML) data sources associated with the media file, Extensible Metadata Platform (XMP) metadata, Exchangeable Image File Format (EXIF) metadata, Picture Licensing Universal System (PLUS) data, and any other embedded metadata source, other metadata source, or combinations thereof.

In an embodiment, a cryptographic hash function may be used to generate a hash for each media file listed or to be listed in the registry. The hash function may create a unique alphanumeric, hexadecimal number for each media file. The hash function maps binary data of the file to short bit strings that make up a hash value for the media file. Examples of hash functions suitable for use with embodiments of the invention include, but are not limited to, MD5, MD6, SHA-1, SHA-2 and other hashes. The resulting identifier may be referred to as a hash, unique identifier (UID), or a “check sum”. The hash may be used as a unique identifier for the media file. A hash may at times not be unique at a frequency of occurrence that is not statistically significant. When a new or potentially-new media file is considered by the system, the registry may search previously-stored hashes to determine whether a record having the same hash is present in the registry. If it is, then the media file may be identified as a media file previously registered with the system. Thus, for example, a rights holder for a work embodied in the media file may be identified. Using such a technique, a rights holder may be identified from a media file that is not controlled by a the rights holder; this may be contrasted by other techniques in which a rights holder initiates an action from a media file known to be owned by the rights holder, such as to find infringers and/or authorized users of the media file.

In an embodiment, a perceptual hash may be generated for a media file using, for example, a feature extraction algorithm. Perceptual hashing is described in further detail in B. Coskun and N. Memon, “On the Confusion/Diffusion Properties of Perceptual Hash Functions”, CISS 2006: Conference on Information Sciences and Systems, Mar. 22-24, 2006, Princeton, N.J., accessible at http://isis.poly.edu/˜baris/papers/conference/confusion_diffusion.pdf. The perceptual hash may be stored in addition to or instead of the hash, and may be used as the unique identifier for a media file. A perceptual hash may at times not be unique at a frequency of occurrence that is not statistically significant When a new or potentially-new media file is considered by the system, the registry may search previously-stored perceptual hashes to determine whether a record having the same hash is present in the registry. If it is, then the media file may be identified as a media file previously registered with the system. Thus, for example, a rights holder for a work embodied in the media file may be identified. If there is no exact match of the new perceptual hash, the hamming distance between the new perceptual hash and perceptual hashes stored in the registry may be compared to determine the quantity of substitutions required to make the strings identical, which provides an indication of the degree of similarity between the new media file and those with records in the registry. The result may be, for example, a hierarchal list from most similar to least similar of the media files. In an embodiment, the use of hamming distances may allow for media files to be grouped based on a subjective variable controlled by the administrator as to what is acceptably similar to be considered the same or a substantially-similar creative work. Quality checks may be performed to reduce the statistical possibility of error of perceptual hash evaluation and hamming. For example, a radial hash differential may be used to further compare media files, and differences between similar media file may be further evaluated by comparing the statistical difference between solarized composites of media files.

In an embodiment, a registry system may allow a rights holder to embed a unique identifier, such as the hash or the perceptual hash associated with a media file, in the media file. For example, if the media file is a pixel-based image file, a symbolic representation of a hash may be placed in a portion of the file by altering the values of certain pixels in the file. A specific example of such a technique suitable for use with the present invention is the Veripixel™ copyright notice developed and provided by The Copyright Registry. In an embodiment, the addition of the identifier to a media file using this or similar methods may be controlled by a rights holder of the media file.

In an embodiment, the media files themselves may not be stored by the registry. For example, a unique identifier, a URL of the media file, a URL of a resource containing or referencing the media file, or any combination thereof may be used to identify or display the media file. When a registry system according to such an embodiment displays the media file to a user, such as when the media file is displayed with associated information, the system may do so by linking or referencing the media file via a URL or other identifier. For example, a digital image may be displayed by linking to a URL at which the image is located.

In an embodiment, some functions or operations may be performed after rights holder information has been associated with a media file. For example, some functionality may be controlled or disabled by an owner or other rights holder. As another example, knowing the creator or owner of a work embodied in a media file, or of the media file itself, may provide additional opportunities to identify further information that can be associated with the media file in a registry system.

In an embodiment, copyright information, an official registration number, the title of a work or other information about a creative work embodied in a media file, may be obtained from the U.S. Copyright Office, such as via the Copyright Office website or other publicly available access method, and conveyed or displayed to a user for a media file. The conveyance or displaying of such information may be together with the media file or exclusive of the media file.

In an embodiment, owner and usage history information may be obtained from the PLUS Coalition, such as via a website or other publicly available access method, and may be conveyed or displayed to a user for the creative works contained in a media file.

In an embodiment, other relevant data and information may be obtained from the registry or third-party databases that may be conveyed or displayed to the user for a media file. For example, the creator/author's name, the rights holder's name, email, phone and fax numbers, web site, or any other rights holder information or combinations thereof may be obtained and conveyed or displayed to a user. To provide privacy protections, rights holders may be provided the option to prevent some or all of this information from being displayed to a user.

The use of a centralized registry for media files may provide additional functionality beyond the ability to identify information associated with a known or arbitrary media file. The registry may be particularly suited for use in identifying creators, owners, and other rights holders of media files and taking other related actions, examples of which are provided herein.

In an embodiment, HTML code may be conveyed or displayed to the user that can be placed on any third-party web site that provides a visual icon and link back to this information about the media file.

In an embodiment, creative works that are similar to a media file for which ownership or other rights holder information is requested by a user may be conveyed or displayed to the user for the media file. As an example, these similar files may be pixel-based images that are visually similar according to a hamming-distance comparison of the perceptual hashes of the images.

In an embodiment, a list may be conveyed or displayed to a user that includes URLs of where exact duplicate copies of the media file have been stored, URLs of the web pages on which exact duplicate copies of the media file have been used, the first date and most recent date recorded for these URLs, and other information relating to locations where an identified or unidentified media file has been found.

In an embodiment, a mechanism may be provided to the user to “ping” any of the URLs at which a media file was previously identified as being used to determine whether the media file is still in use at that URL or web page.

In an embodiment, if no exact match is found to a hash or a perceptual hash of a media file identified by a user, a list of possible copyright holders and rights holders is conveyed or displayed to the user for the media file with links to those records. The list may be of visual content, such as images, displaying similar media files or as text or other form of information display.

In an embodiment, if a user is the rights holder for a particular media file, he may be provided the option to “lock” (i.e., prevent further changes to) and “unlock” the media file record in the registry, to prohibit anyone but the rights holder from altering the record for the media file.

In an embodiment, a rights holder may alter a media file by inserting a series of colored pixels that represent a hash or other identifier of the media file.

In an embodiment, a mechanism may be provided for a user to dispute the ownership claim of another user by formally initiating a complaint in the registry system. Upon the user taking this action, a notice may be displayed or conveyed to users from the media file record in the registry indicating that ownership of the media file is in dispute. Similarly, in an embodiment, an existing dispute known to the registry between claimed owners of a media file may be displayed or conveyed to a user for the media file. The system further may provide a dispute resolution process in which the plaintiff and the claimant of record may upload digital files, URL links, text or any other evidence to support their claims and counter claims.

In an embodiment, the system may provide a mechanism for a user to contact the rights holder of the media file directly, such as via an internal communications method that provides for double blind communication between the parties. A recipient of such communications may opt to block receiving future communications from that user.

In an embodiment, the registry system may provide a mechanism to create and receive a report, for example in PDF form, that documents various information for the media file. The report may be recorded in a system to enable later verification of the authenticity of each report issued. For example, a report may be stored as a media file in the system, and later verified via comparison of a unique identifier hash that is derived from the report after creation. Information provided in the report may include past query and usage history, claimed rights holder on file for a media file, whether any rights holder(s) are known for a media file, whether the creative works contained in the media file may be a non-attributed work for which no owner is known or contactable, a list of URLs where the media file has been used or published online, dates of known use, URLs where the media file has been stored, URLs of pages at which the media file has been used, or any other information stored in the registry for one or more media files, or any combination thereof.

The use of reports, especially verifiable reports, may allow for additional functionality in the registry system, and may provide additional options for rights holders to take action with respect to potential infringement. In an embodiment, users can create and send to the responsible Internet Service Provider a report form that documents the time and URL of an unauthorized use. This may be used, for example, to order the removal of a media file from a web site according to the notice and take-down provisions of the Digital Millennium Copyright Act.

In an embodiment, users may create and receive a report that documents the formalized initiation of a dispute resolution process, and update of arguments and evidence provided by both sides concerning the rights claimed in the registry or networked databases for the media file.

In an embodiment, users may create and receive a report that documents the conclusion and final decision of a dispute resolution process by the administrators of the company overseeing the registry system, which may include the totality of arguments and evidence provided by both sides concerning the rights claimed in the networked databases for the media file.

In an embodiment, users may create and receive a report that documents that a report previously issued by the process is the exact same report that was issued previously, thus verifying its authenticity, for the media file. This secondary report also may be verifiable, for example, using one or more hashes or other unique identifiers as previously described.

Embodiments of the invention may be particularly suited for use with specific types of media files, such as non-text files, pixel-based media files, images (e.g., JPEG, TIFF, GIF and other formats), audio files (MP3, WAV, and the like), videos (MP4, MPEG, and the like), or combinations thereof.

In general, a media file may include multiple works of authorship, and a single work of authorship may be embodied in multiple media files. Similarly, a single rights holder may have rights to multiple media files, and multiple rights holders may have rights in a single media file. Embodiments of the invention allow for arbitrary association of rights holders and media files, thus allowing for one-to-many, many-to-many, many-to-one, and one-to-one relationships between rights holders and media files.

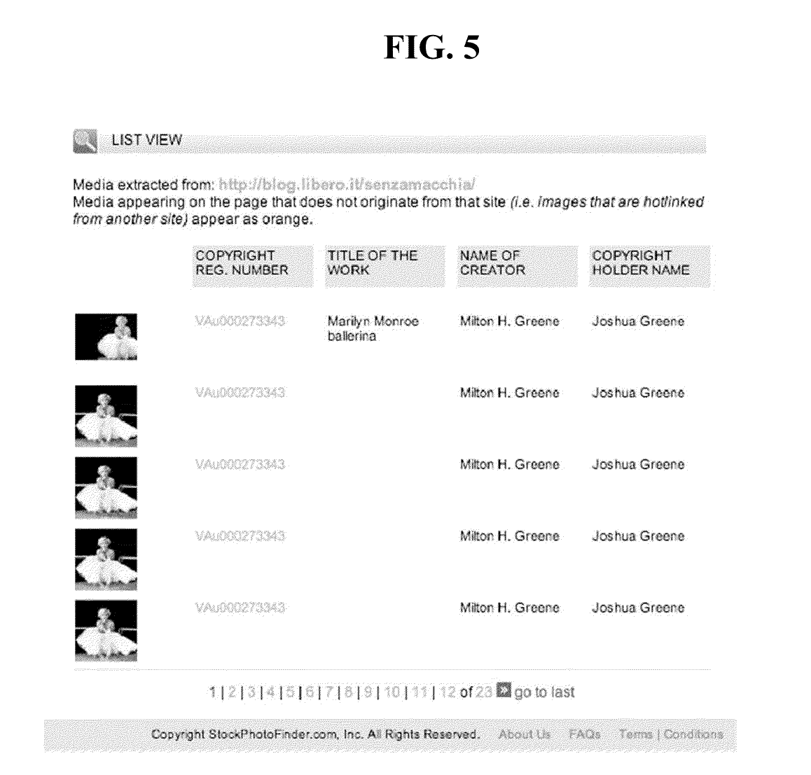

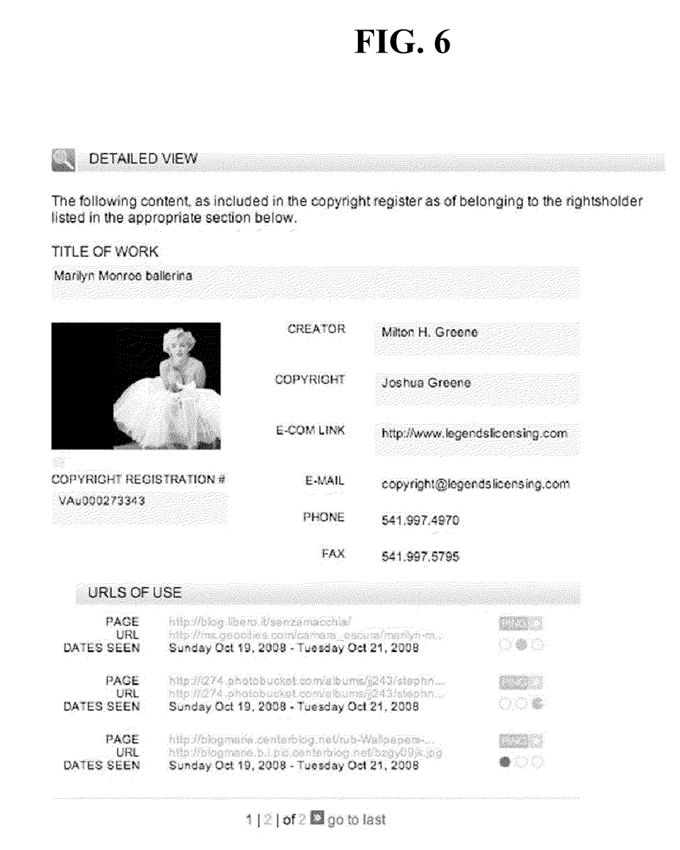

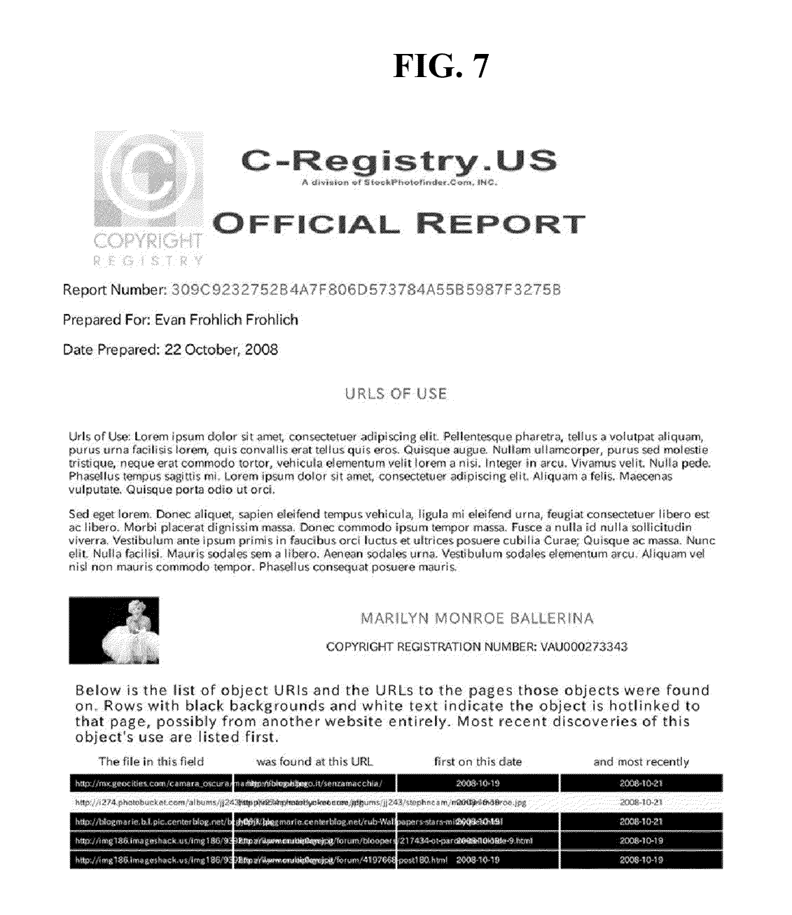

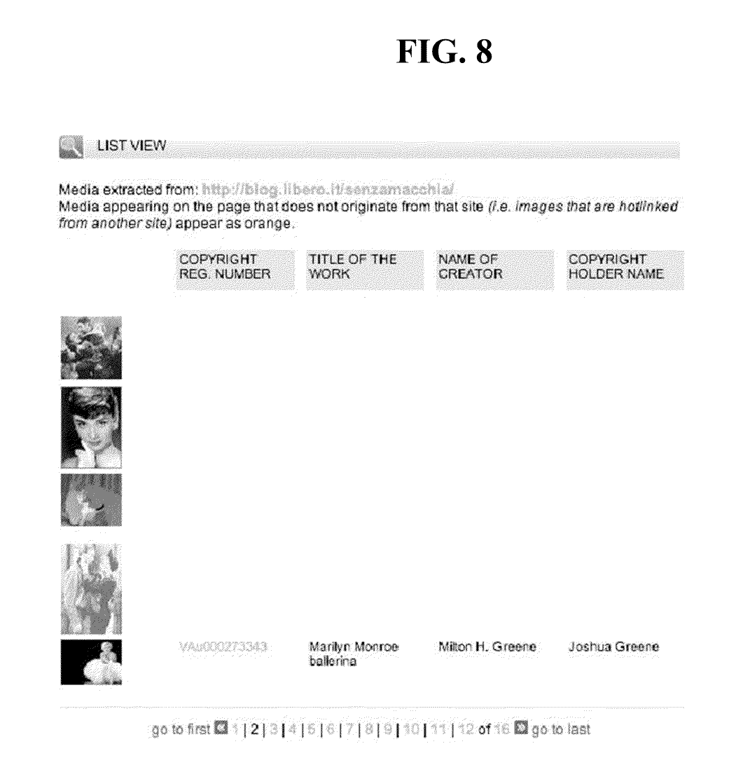

FIGS. 5-8 show example user interfaces for accessing and using a registry according to an embodiment of the invention. Specifically, FIG. 5 shows an example of a user interface for displaying the media files identified at a particular URL; FIG. 6 shows an example of a user interface displaying detailed information for a single media file; FIG. 7 shows an example report for a single media file; and FIG. 8 shows an example user interface displaying the media files at a particular URL that includes media files both registered and not registered in the associated registry.

As previously described, embodiments of the invention may be particularly suited to identify a copyright holder or other rights holder for images on the Internet that are otherwise unidentified. The following chart shows an example process for identifying a rights holder according to an embodiment of the invention, in which interaction with a registry is shown by a filled circle:

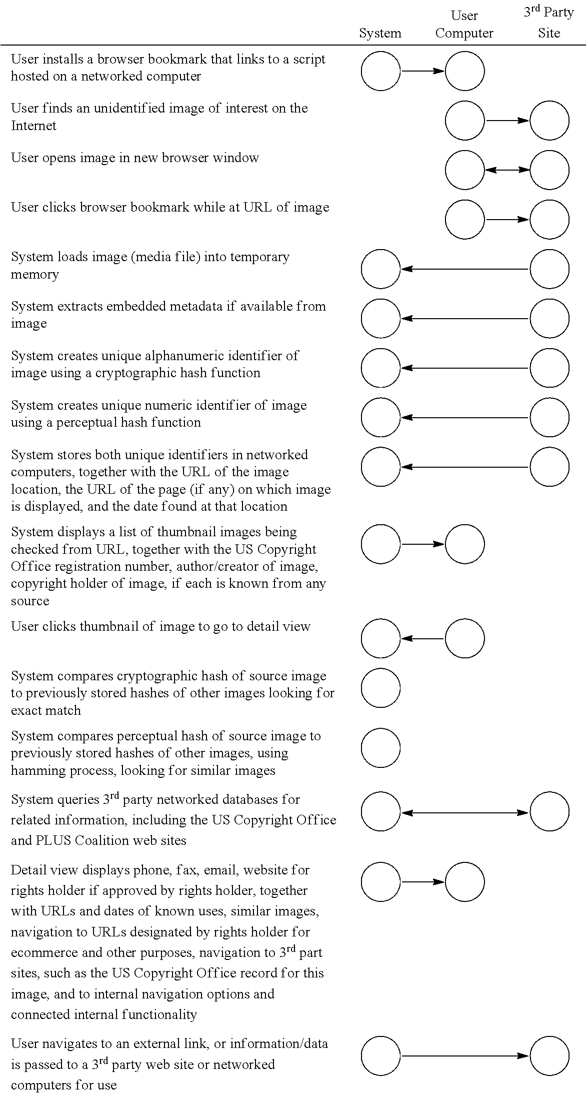

Embodiments of the invention may use variations on the particular techniques described herein, and may combine and/or omit features described herein. For example, in an embodiment a text-based search may be used to identify a particular media file, such as by searching for the filename of the media file. As another example, unique identifiers may be generated using techniques other than the hashing techniques previously described. In an embodiment, attributes of a media file may be stored, used as a unique identifier, or used to generate a unique identifier. These media file attributes may include histograms, vertical vs. horizontal characteristics, image size, image features, object or scene identifiers, colors, contrast ranges or ratios, density, wave patterns, volume, broadcast or playing length, statistical methods of comparing aspects or attributes of media files, other attributes, or any combination thereof.

The techniques described herein also may be applied to portions of a media file. For example, a media file may be divided into sections and each section processes as if it is a separate media file. Media files also may be organized and searched based on the types and content of embedded metadata associated with the media files.

As described herein, embodiments of the invention may allow for users to identify and contact rights holders of various creative works from a media file containing the creative works. Thus, in some embodiments, the invention may allow for rights holders to be identified for non-attributed works, thus allowing them to be re-classified as attributed works. For example, in an embodiment a user may submit a media file embodying a non-attributed work to a registry system as described herein. The registry system may generate a hash and/or a perceptual hash to find identical and similar media files registered with the system. Similar media files may be grouped based on, for example, similarities in the perceptual hash. These groups may be stored in the registry system, such as by using a group identifier. Thus, the registry system may be able to quickly provide sets of related media files based on a single media file received from a user and, therefore, associate the rights holder of a known media file with the non-attributed work of an unknown media file.

A registry system as described herein also may allow for various rights holder information to be aggregated and linked. For example, information from various sources (e.g., embedded metadata) may be compared to other sources, such as data received from a registered user, who may be the rights holder for a media file. Other databases and similar systems also may be queried for information, such as the U.S. Copyright Office, UsePlus.org and similar databases or web sites. This information may all be linked to a unique identifier for the media file in the registry system. Thus, a registry system as described herein may act as a hub or other central resource for rights holder information for a variety of media files from a variety of sources.

In an embodiment, a system according to the invention may provide for registration of ownership and/or other rights associated with a media file. For example, a user may place Java or HTML or other computer code (referred to herein as “HMTL code”) on a web page or device, which may cause the media files on the page or device, and all media files later added to the page or device later to be automatically registered with the ownership information of the person who initiated the code. The ownership rights also may be automatically registered with the U.S. Copyright Office. In a specific example, a user may log in to a registry system, with which he has previously created an account. The system may then generate HTML or other code with a unique identifier that is linked to the user's account or profile in the registry system. The HTML code then may be placed on a web page or device controlled by or associated with the user. For example, the code may be placed in a recurring element across a website having multiple web pages, such as by including the code in a common header or footer element. In such a configuration, the functionality embodied in the generated code may be replicated across an entire site or set of web pages. When an end user accesses a web page that includes the code, the code may check to see if media files on the page have already been verified or otherwise processed by the registry, or if they have been verified within a certain time span. If not, the code may send the URL of each un-verified or un-registered media file on the web page or device to the registry system. The registry system then may analyze each media file as described herein and add any previously unregistered media files to the registry. The newly-added media files may be automatically associated with rights holder information by virtue of the unique identifier included in the generated code. Similarly, automatic registration techniques may be used with media files generated or stored by sources other than web pages, such as cameras, image software, video software, mobile phones and other computing devices, or any other source of media files.

Although described with respect to systems and methods for identifying rights holder information for media files, embodiments of the invention may have applicability to a wide range of other fields and uses. For example, information other than that previously described may be associated with media files, or the various lookup and comparison methods may be used in applications other than identifying rights holder information for a media file.

Specifically, embodiments of the invention may provide methods and systems to perform reverse pattern recognition matching. As used herein, “reverse pattern recognition matching” refers to the technique of using a media file, such as an image, video, or song, as a source to initiate a search to find copies of the media file or similar media files by creating and comparing one or more unique identifiers, which typically are generated using cryptographic and/or perceptual hash functions. Different media files may have different reverse matching techniques associated with them. For example, “reverse image recognition matching” refers to a reverse pattern recognition technique that is used for digital images.

In the context of identifying rights holders as previously described, reverse pattern recognition matching may allow rights holders to be identified based on an arbitrarily-identified image. In contrast, other techniques for locating potential copyright infringement often begin with an original work and attempt to identify infringers.

More generally, reverse pattern recognition matching techniques may be used for virtually any application in which identical or similar digital files are to be identified from an original file that has little or no other information associated with it. Reverse pattern recognition matching also may utilize variable controls to limit the degree of variation from the original, ranging from exact match to approximately similar, as previously described with respect to the ability of a media file registry to identify similar media files. A few specific examples of such applications will now be described, but it will be understood that the invention is not limited to these specific examples.

In an embodiment, government law enforcement and/or security forces may employ reverse pattern recognition matching to find “like-minded” people of interest by using a media file to which they have access to find and track web sites and digital devices that use the same or similar files. As a specific example, a photo, video or song that is seized in a raid or found at a suspect's web site may be used to locate other web sites, mobile phones and other digital devices that have displayed, stored or relayed the same or similar content. A racist hate song, a child porn video or an image of a possible target obtained from a criminal or suspect may be used to locate the same content elsewhere, acting as an investigative lead to discovering other possible criminal activities by like-minded individuals or groups.

In an embodiment, when applied to cloud computing, reverse pattern recognition matching may track digital files as they pass from one digital device to another, including across systems other than the Internet. For example, images passing from cell phone to cell phone may be tracked and the transfers regulated or monetized.

Companies and their legal representatives often may desire ways to limit the sale of counterfeit products. In an embodiment, companies can use image files at their publicly accessible web sites that contain company logos as the source media file to initiate reverse pattern recognition matching searches of web sites that are using duplicates or substantially similar logos. There is a likelihood, for example, that unauthorized web sites displaying a Gucci logo may be engaged in selling counterfeit Gucci products. Reverse image recognition matching may facilitate finding these web sites that use the official logo without authorization. The same is true for a variety of brands from sports franchises to car companies. Upon discovering the infringing use of their logo, companies, which are rights holders in that image, can ask the hosting Internet Service Provider of the infringing site to remove the logo, as required by the Digital Millennium Copyright Act. This approach may restrict the illegal activities of the counterfeit sales web site faster than legal or criminal action.

In an embodiment, reverse image recognition matching may be used to locate images of goods and services within a controlled network of e-commerce sales channels. For example, a consumer may start with a product image at a web site, such as a picture of a particular car, or a travel destination, or a handbag. From each image, identical and similar images can be found in restricted computer networks that offer goods and services for sale, such as from new and used car dealers, travel agencies and women's accessories stores, for example.

Traditionally, searching for real estate is done by text criteria search. Many home buyers are looking for a house that matches an image of their desired home, which they may have in their minds eye. Using reverse image recognition matching, home shoppers may start with any image of a house found on the Internet from anywhere in the world, and use that image as the starting point for a search. Since architectural design can be repetitive within the grouping of all houses on earth, there potentially will be large quantities of substantially similar houses in the search results. When coupled with or filtered by a limited network of databases for home sales that cross references region and price, home buyers can use reverse image recognition matching to more quickly find an appropriate home to purchase or rent.

Because the search method can be visual in nature, in an embodiment, reverse image recognition matching may be used by handicapped individuals and those with reading disabilities, such as dyslexia. For example, a substantially paralyzed individual may use as a starting point for search a limited selection of visual images. Upon selecting one image, a broader selection of similar images may appear with a user-controlled amount of variance from the original image. Multiple passes of expanding search by image recognition may lead the user through a limitless array of uncontrolled images to the subject of interest from a starting point of a limited set of images. This process may be language neutral.

Social media and photo sharing web sites currently have more than 50 billion images online, and this quantity is growing rapidly. The vast majority of these images have no or insufficient captioning, keywording or tagging. In an embodiment, reverse image recognition matching may enable fully- or partially-automated keywording of images based solely on the visual properties of the image. The image to be keyworded may be used as a source to find other images that are substantially similar from a limited pool of well-keyworded images, such as an aggregated search of professional stock photo agencies. The keywords associated with the similar images may be then prioritized in a descending hierarchy of frequency for which these words are found in the set of images. A variable control may be used to determine the degree of similarity between the images in the set that includes keywords with the unkeyworded image that initiates the search. With a fully automated process, reverse image recognition matching can keyword with images that are not currently searchable by keyword, thereby extending the access and usefulness of those images.

As printed books, newspapers and magazines are scanned or digitized, new methods of finding relevant information within publications are needed. Books that originate in non-English languages or English books being sought by non-English speakers may not be findable in searches, depending on the broad and interpretive variations of translations that might be used when compared to a broad variation of search terms input by the user. In an embodiment, visual images may be used to search for books on related topics by using reverse image recognition matching. Professional images are distributed worldwide for use by publications by media distribution companies, and there is a certain amount of redundancy in images used and topic illustrated in publications worldwide. An embodiment of the invention may enable users to find books, newspapers, research papers, magazines and other periodicals on related topics in multiple languages, in multiple years of publication, in and out of print by finding publications with similar images to the initiating image.

More generally, reverse pattern recognition matching may be applied in a variety of fields and for a variety of applications, including, for example, law enforcement and security, cloud computing, digital resource tracking and monitoring, trademark monitoring, e-commerce, architecture and real estate, accessibility, regulatory compliance, social media and media sharing, publication indexing and retrieval, military and governmental operations, advertising, graphic arts, urban planning, supply chain management, entertainment, video production, web design, and others.

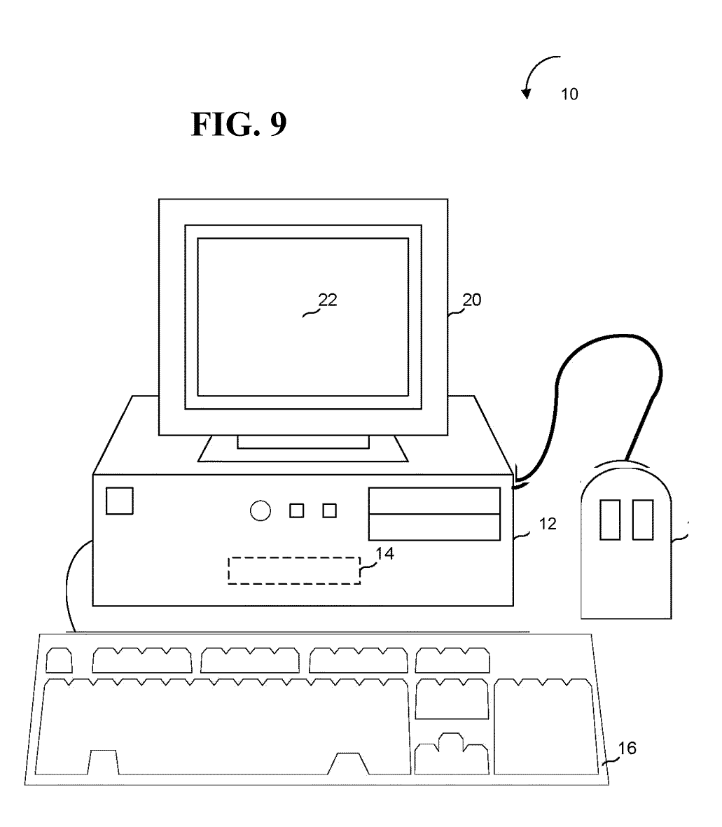

FIG. 9 shows a computer suitable for use with embodiments of the present invention. The computer 10 may include a processing unit 12, which may include one or more computer readable storage media 14. The computer may interface with a human operator via an output 20, which may include a visual display 22 to display text, graphics, video, and other visual data. The computer may receive input via a mouse 18, keyboard 16, and/or any other suitable user interface. The general operation of the computer 10 will be understood to one of skill in the art.

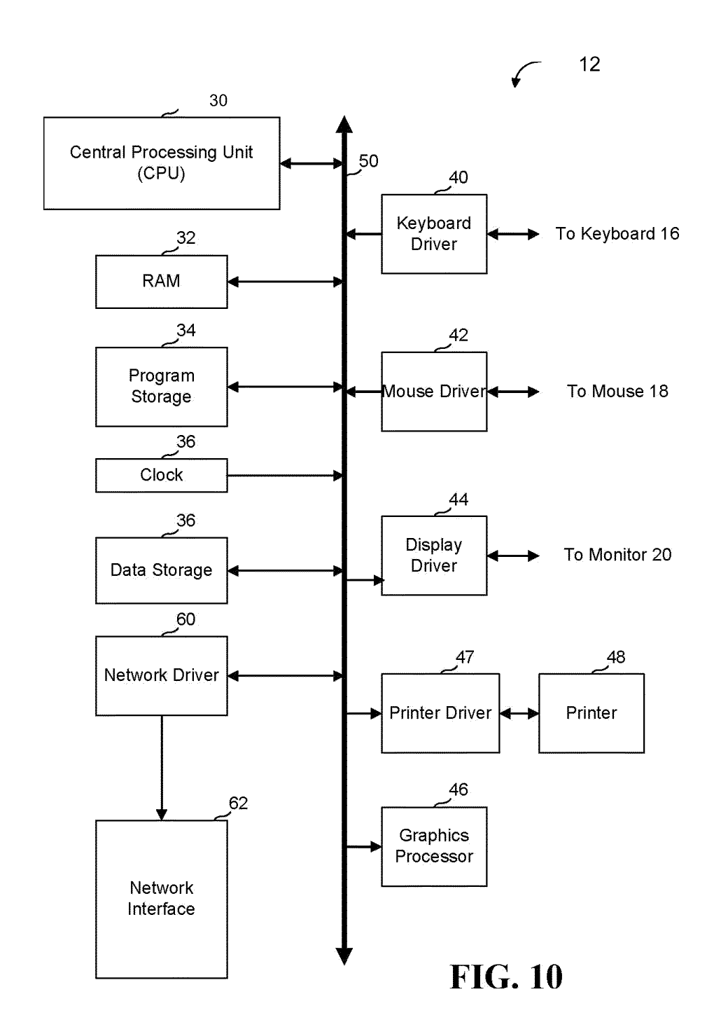

FIG. 10 shows a schematic diagram of the processing unit 12. A central processing unit 30 may communicate with various other components via a main bus 50 and other suitable communication lines (not shown). Data may be stored in volatile memory such as RAM 32, program storage 34 and/or data storage 36. The program storage 34 and/or data storage 36 may include various types of computer-readable media, such as CD-ROMs or other type of optical disks, floppy diskettes, ROMs, RAMs, EPROMs, EEPROMs, magnetic or optical cards and drives, flash memory, or other types of machine-readable mediums suitable for storing electronic instructions. Computer-readable instructions may be stored in the program storage 34. When executed by the computer, these instructions may cause the computer to implement specific methods as described herein, and may cause the computer to operate in accordance with those methods. In an embodiment, execution of the instructions stored in the program storage 34 may transform a general-purpose computer into a computer configured to perform one or more methods embodied by the instructions. A clock 36 may be used to synchronize operation of the other elements of processing unit 12. A network driver 60 may manage connections between a network interface 62, such as a TCP/IP or other suitable interface, to allow the computer to communicate with other computers, operators, or other entities. A keyboard driver 40 may communicate with the keyboard 16 to receive input from an operator. A mouse driver 42 may manage communication with the mouse 18 to coordinate reception of input signals. A display driver 44 may manage communications between the processing unit 12 and the monitor 20, such as to display appropriate output on the monitor 20. Similarly, a printer driver 47 may manage communications with a printer 48. A graphics processor 46 may generate and manage manipulation and display of graphical elements such as 2D images, 3D images and objects, and other visual elements. The general operation of the various components shown in FIG. 10 otherwise will be understood by one of skill in the art.

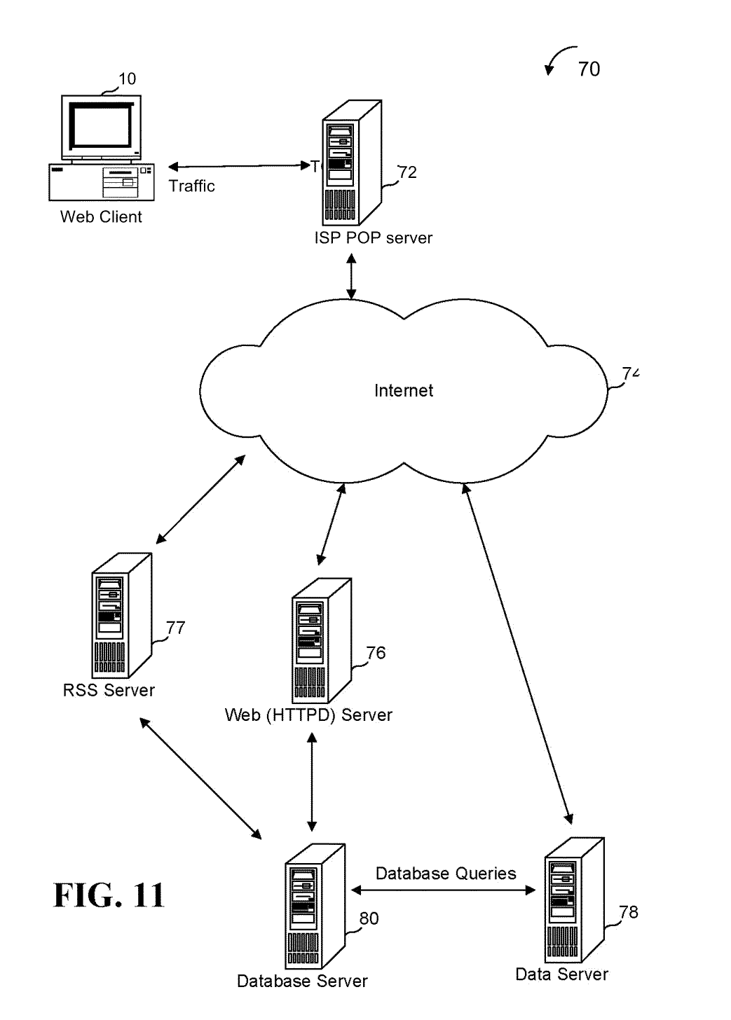

FIG. 11 shows an example of a computer network 70 suitable for use with the present invention. A client such as the computer 10 may access the Internet or other network via a point of presence server 72 or other server, such as provided by an ISP. The computer 10 may access various servers, such as a web or HTTP server 76, an RSS server 77, or other suitable server or other information provider. As previously described, the various computers 10, 76, 77 may communicate with one or more databases 80 or other data servers 78 to retrieve information. The general operation of the network 70 and the various components shown in FIG. 11 otherwise will be understood by one of skill in the art, and other arrangements suitable for use with the invention will be readily apparent to one of skill in the art.

An embodiment of the invention may be embodied in the form of computer-implemented processes and apparatuses for practicing those processes. Embodiments also may be embodied in the form of a computer program product having computer program code containing instructions embodied in tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing the invention. Embodiments of the invention also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the invention. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments of the invention may be used with any suitable computing or processing device, including mobile phones and other mobile computing devices, digital cameras, “cloud” computing systems and other networked computing devices, and any other device known in the art. In addition, various components may include or be provided by software components, such as imaging, video, and other software. For example, media files may be automatically or semi-automatically provided to a registry system for verification and/or registration by various software components.

Examples provided herein are merely illustrative and are not meant to be an exhaustive list of all possible embodiments, applications, or modifications of the invention. Thus, various modifications and variations of the described methods and systems of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention which are obvious to those skilled in the relevant arts or fields are intended to be within the scope of the appended claims.

The disclosures of all references and publications cited above are expressly incorporated by reference in their entireties to the same extent as if each were incorporated by reference individually.

What is claimed is:

1. A computer-implemented method comprising:
receiving an identification of a media file from a user;
generating a unique identifier for the media file;
searching a media file registry for the unique identifier, the media file registry storing a plurality of records, each record associating a previously-generated unique identifier for a media file with rights holder information for the media file;
identifying a second media file similar to the media file identified by the user by comparing unique identifiers associated with the identified media file and the second media file;
retrieving rights holder information for the media file from the registry; and
presenting the rights holder information to the user.

2. The method of claim 1, further comprising the step of displaying the media file to the user concurrently with the rights holder information.

3. The method of claim 1, further comprising the step of receiving the rights holder information for the media file from a rights holder.

4. The method of claim 2, further comprising the step of obtaining the rights holder information from a third-party source.

5. The method of claim 4, wherein the third-party source is a government-run copyright registry.

6. The method of claim 1, further comprising providing the user with the ability to perform a commercial action related to the identified media file.

7. The method of claim 6, wherein the commercial action is obtaining a license to use the media tile, obtaining an authorized copy of the media file, obtaining a report describing rights holder information for the media file, or a combination thereof.

8. The method of claim 1, wherein the media file is not controlled by the rights holder.

9. The method of claim 1, further comprising the step of identifying the rights holder of the media file from a copy of the media file that has no rights holder information provided at the location of use of the media file.

10. The method of claim 1, further comprising the step of providing contact information for the rights holder of the media file whether or not the contact information was known at the locution of use of the media file.

11. A computer-implemented method comprising:
receiving an identification of a media file from a user;
generating a unique identifier for the media file;
receiving rights holder information from the user; and
storing a record of the unique identifier and the rights holder information in a media file registry.

12. The method of claim 11, further comprising the step of displaying the media file to the user concurrently with the rights holder information.

13. The method of claim 11, further comprising the step of displaying a list or similar media files to the user.

14. The method of claim 11, further comprising the step of obtaining additional rights holder information from a third-party source.

15. The method of claim 14, wherein the third-party source is a government-run copyright registry.

16. (canceled)

17. The method of claim 1, wherein the unique identifiers are perceptual hashes.

18. The method of claim 1, further comprising comparing the unique identifiers by calculating a hamming distance between the identifiers.

19. The method of claim 11, further comprising generating source code for a web page, the code being configured to register one or more media files on the web page in the media file registry.

20. The method of claim 19, wherein the generated code limits usability of the code to a specific web domain.

21. The method of claim 19, wherein the generated code limits usability of the code to a specific user.

22. The method of claim 19, wherein the generated code automatically adds a unique identifier and information to the media file registry for all media files at a web page containing the code.

23. The method of claim 19, wherein the generated code stores data used to limit usability of the code in a browser cookie of the user.

24. The method of claim 19, wherein the generated code is activated by a user loading the web page in their web browser.

25. The method of claim 19, wherein the generated code checks for additions of new media files to the web page and registers those new media files in a media file registry.

26. The method of claim 19, wherein the generated code determines if media files on the web page containing the code have already been added to the media file registry and does not add the media files on the web page to the registry if the web page is unchanged since a previous verification.

27. The method of claim 11, further comprising registering the media file in a government-run registry.

28. The method of claim 27, wherein the media file is automatically registered based on saved preferences of the user.

29. The method of claim 27, wherein said step of registering the media file comprises the step of assembling necessary information from the media file registry.

30. The Method of claim 11, further comprising receiving a second unique identifier and information for the media file; the media file being created in and transmitted from a mobile phone; and storing the second unique identifier and the received information in the media file registry.

31. The method of claim 11, further comprising receiving a second unique identifier and information for the media file, the media file being created in and transmitted from a digital camera and storing the unique identifier and the received information in the media file registry.

32. The method of claim 11, further comprising receiving a second unique identifier and information for the media file, the media file being used or modified with computer software; and storing the second unique identifier and the received information in the media file registry.

33. The method of claim 11 further comprising identifying a plurality of other media files and storing a unique identifier for each of the plurality of other media files in the media file registry.

34. The method of claim 11, wherein the media file registry does not store a copy of the media file identified by the user.

35. (canceled)

36. A system comprising:
a database to store a plurality of records, each record associating a previously-generated unique identifier for a media file with rights holder information for the media file; and
a processing module comprising:
an input to receive an identification of a media file from a user;
a processor to generate a unique identifier for the media file and to search a database for the unique identifier, and to retrieve rights holder information for the media file from the database; and
an output to present the rights holder information to the user.

37. A system comprising:
a database; and
a processing module comprising:
an input to receive an identification of a media file from a user;
a processor to generate a unique identifier for the media file, to receive rights holder information from the user, and to store a record of the unique identifier and the rights holder information in the database.

38. (canceled)

39. A computer-readable storage medium storing a plurality of instructions which, when executed by a processor, cause a processor to perform a method comprising:
receiving an identification of a media file from a user;
generating a unique identifier for the media file;
searching a media file registry for the unique identifier, the media file registry storing a plurality of records, each record associating a previously-generated unique identifier for a media file with rights holder information for the media file;
retrieving rights holder information, for the media file from the registry; and
presenting the rights holder information to the user.

40. A computer-readable storage medium storing a plurality of instructions which, when executed by a processor, cause a processor to perform a method comprising:
receiving an identification of a media file from a user;
generating a unique identifier for the media file;
receiving rights holder information from the user; and
storing a record of the unique identifier and the rights holder information in a media file registry.
